(19) United States
(12) Patent Application Publication
(10) Pub. No.: US 2015/0120580 A1
(43) Pub. Date: Apr. 30, 2015

(54) METHOD FOR AUTOMATIC DEVELOPMENT OF AN ART INDEX

(71) Applicant: ARTNET WORLDWIDE CORP., New York, NY (US)

(72) Inventors: Jacob Karl Stanley Pabst, New York, NY (US); Thomas Griffith Galbraith, Brooklyn, NY (US)

(73) Assignee: ARTNET WORLDWIDE CORP., New York, NY (US)

(21) Appl. No.: 14/397,840

(22) PCT Filed: Mar. 14, 2013
(86) PCT No.: PCT/US2013/031404

§ 371 Date: Oct. 29, 2014

Related U.S. Application Data
(60) Provisional application No. 61/640,501, filed on Apr. 30, 2012.

(51) Int. Cl. G06Q 30/02; G06F 17/30

(52) U.S. Cl. CPC G06Q 30/0278; G06F 17/3002
USPC 705/306

(57) ABSTRACT

Systems and methods for automatically generating an art index. The method is both sympathetic to the individual characteristics of art—a hedonic approach—and accurate in tracking changes in price over time—a repeat sales approach. Artworks with similar core characteristics are organized into groups according to their specific criteria. The characteristics include genre, date range, content, materials, size, coloration, style, and other characteristics. Following these guidelines, the system is able to generate hundreds of thousands of ever-increasing datasets, providing the statistical foundation required to derive accurate indices, while remaining true to the unique nature of art. The system is also operative to generate various types of reports.

### FIELD OF THE INVENTION

The present invention relates generally to systems and methods for tracking change in price in the art market, particularly to systems and methods for automatically generating art indices.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

The art market is often criticized for being opaque and challenging for new and seasoned participants alike. Analysis is often subjective, and if data is used, it is routinely selective or improper, leading to ill informed, misleading, or at worst, manipulated conclusions. In order for the art market to be, more widely accepted as a viable alternative asset, better transparency is necessary.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 illustrates the quantity of art sales information included in the index methodology utilized according to an embodiment of the present invention.

FIG. 2 illustrates a process for generating art indices according to an embodiment of the present invention.

FIG. 3 illustrates an example of a comparable set of artwork used to generate art indices according to an embodiment of the present invention.

FIGS. 4A-4B illustrate a second example of a comparable set of artwork used to generate art indices according to an embodiment of the present invention.

FIGS. 5A-5C illustrate a third example of a comparable set of artwork used to generate art indices according to an embodiment of the present invention.

FIG. 6 illustrates a fourth example of a comparable set of artwork used to generate art indices according to an embodiment of the present invention.

FIG. 7 illustrates an example report index graph for an artist index as compared with two other indices.

FIG. 8 illustrates an example report index graph for a combined artists index as compared with another index.

FIG. 9 illustrates an example report index graph for compared artists index.

FIG. 10 is a block diagram of an example computer hardware and operating environment in which the methods described herein may be implemented.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Against the background discussed above, the present inventors have invented a sophisticated art index methodology utilizing a large, aggregated public art market database. For art analysts, it has always been a challenge to consider the individual qualities of an artwork while establishing a system to treat art data in a more scientific manner. To standardize and catalogue a market with the limitations of having a high level of heterogeneity paired with limited liquidity and turnover can result in increasingly complex solutions.

Previous attempts have been made, both in academia and commercially, to develop a meaningful art index. Commercially available indices generally use three differing methodologies: repeat sales, hedonic regression, and price-based approach. To date, none of these indices arguably reflects the complex specificities of the art market.

The inventors have developed an art index that is both sympathetic to the individual characteristics of art—a hedonic approach—and accurate in tracking changes in price over time—a repeat sales approach. A combination of these two methodologies may be considered as a conclusive index method as it combines the best attributes of each method.

The systems and methods of the present invention organize artworks with similar core characteristics into groups according to their specific criteria, implemented in accordance with USPAP (Uniform Standards of Professional Appraisal Practice) guidelines. The characteristics include genre, date range, content, materials, size, coloration, and style. Following these guidelines, the system is able to generate hundreds of thousands of ever-increasing datasets, providing the statistical foundation required to derive accurate indices, while remaining true to the unique nature of art. In doing so, the inventors have developed the first effective and reliable art market index, which is testable in its method, transparent in its dataset, and extremely accurate.

What follows is a discussion on the various modules of an embodiment of an index generation system of the present invention, the calculations involved in generating the indices, and a guide through the process of viewing and understanding the indices.

Index Generation Methodology

One of the biggest challenges to developing an effective art index is the control of the underlying heterogeneity of artworks. Published literature on art index methodologies suggests two modeling approaches to control for heterogeneity: Repeat Sales Regression and Hedonic Regression.

Repeat Sales Regression (hereafter RSR) uses repeat sales data of the same object, and calculates the index value using the price difference between the two selling points. See Ginsburgh Victor, Jianping Mei, and Michael Moses. “On the Computation of Art Indices.” Handbook of the Economics of Art and Culture. Amsterdam: Elsevier, 2006. 948-79. RSR controls for some heterogeneity by considering the price change of the same object whose basic underlying characteristics, such as medium and size, do not change over time.

Hedonic Regression (hereafter HR) generates index values based on artwork characteristics, such as artist, size, medium, and subject matter, and places less importance on the value change of a specific object over time. See Chanel, Olivier, Louis-AndréGérard-Varet, and Victor Ginsburgh. “The Relevance of Hedonic Price Indices.” Journal of Cultural Economics 20.1 (1996):1-24. This separation of hedonic elements of an artwork allows HR to consider how different characteristics affect the value of an artwork.

The publication On the Computation of Art Indices compares these two approaches in terms of number of observations, sample bias, specification bias, revision volatility, price inflation, and exchange rates. See Ginsburgh, Victor, Jianping Mei, and Michael Moses. “On the Computation of Art Indices.” Handbook of the Economics of Art and Culture. Amsterdam: Elsevier, 2006. 948-79. While the RSR method may be criticized for sample bias due to availability of fewer repeat sales data, HR method is criticized for its specification bias, as the functional form of the hedonic element of the artworks may lead to mis-specification problems, particularly when the form changes.

Concerns have been raised as to whether or not one can assume the coefficients of the hedonic variables to be constant over time. See Ginsburgh, Victor, Jianping Mei, and Michael Moses. “On the Computation of Art Indices.” Handbook of the Economics of Art and Culture. Amsterdam: Elsevier, 2006. 948-79. These concerns have largely been addressed and the HR approach has been refined for the purposes of art indexing. See Bocart Fabian Y. R. P., and Christian M. Hafner. “Econometric Analysis of Volatile Art Markets.” Computational Statistics & Data Analysis, 2012, 3091-3104. Nevertheless, if the purchase and the sales price of every object sold over a long period of time are known, RSR can be a more efficient measure of financial return for the art market. Ginsburgh, Mei, and Moses recommend the RSR method when the number of pairs is large, or when the timeframe is greater than 20 years. See Ginsburgh, Victor, Jianping Mei, and Michael Moses. “On the Computation of Art Indices.”

Expanding on the RSR approach to a wider dataset, by considering pairs of comparable pieces of art (“comparables”) in lieu of proper repeat sales, overcomes the largest criticism of the approach and results in a more robust dataset to create indices. In embodiments of the present invention, auction lots from an art price database, such as the ARTNET® Price Database, are used to identify comparable works by the same artist, thereby creating a unique dataset with the largest possible input.

Generated indices include both repeat and single sales, using only information from items that can be grouped as “comparables” (hereafter comparable sets). Therefore, the calculation structure used for generating the indices incorporates aspects of repeat sales, in that it uses results from the sale of artworks that are homogenously grouped, and of hedonic sales, in that it considers each artwork individually during the estimation process.

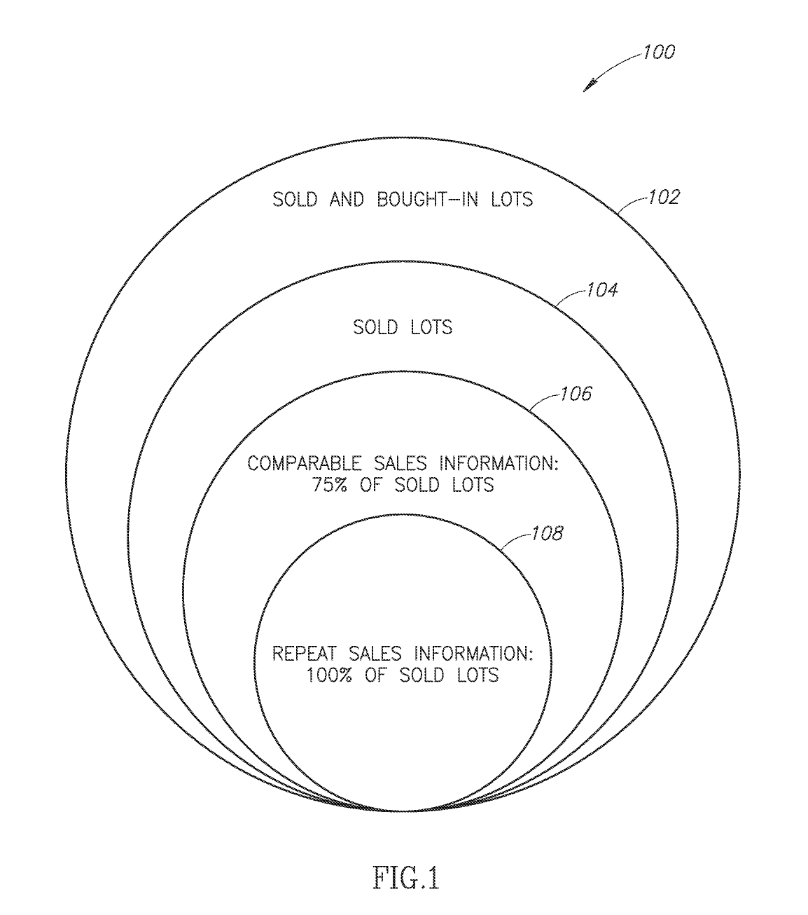

FIG. 1 is a diagram 100 that illustrates the quantity of art sales information included in the index methodology of the present invention when using the ARTNET® Price Database. Shown are sold and bought-in lots 102, sold lots 104, lots 106 with comparable sales information, and lots 108 with repeat sales information. Of the 7 million lots in the database, approximately 75% (i.e., the lots 106) may be grouped into comparable sets of artworks. In some embodiments, all lots in this 75% are included in the index calculation, and only 10% of them may be grouped into pure repeat sales lots 108.

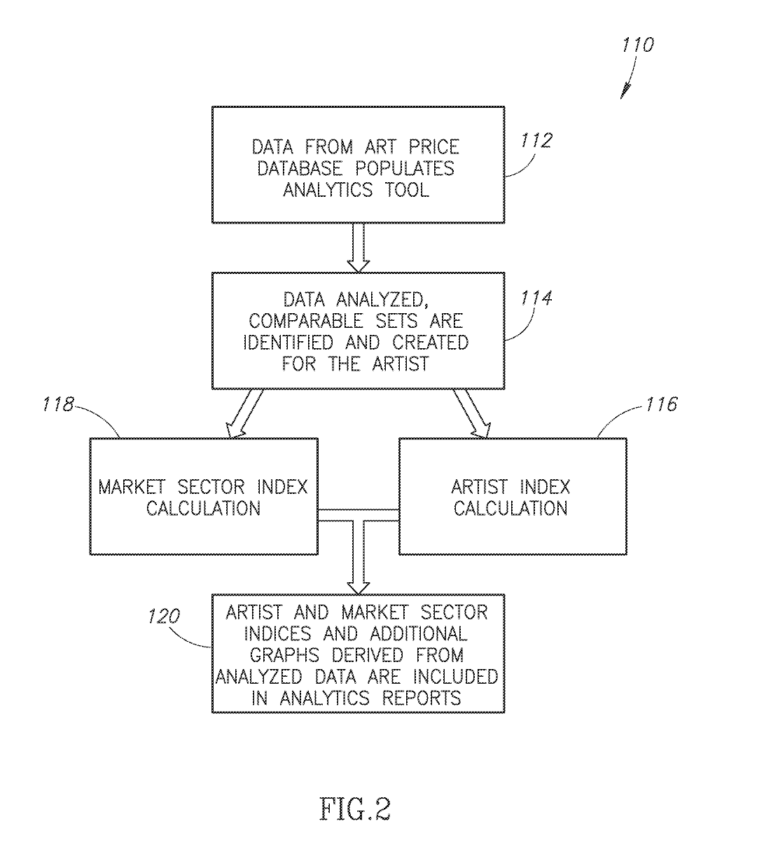

FIG. 2 illustrates a process 110 for generating art indices according to an embodiment of the present invention. As shown, at a macro level, the index system generally comprises a plurality of stages or steps of information processing. In the first step 112, data from a price database (e.g., the ARTNET® Price Database) is imported into an internal analytics tool or computing system. After the data has been imported, at step 114 the system and/or art experts examine, research, and group a single artist's sales data into comparable sets based on appraisal principles and art historical knowledge. This step may be performed automatically by the system, manually, or a combination thereof. Next, in step 116, these groups are used to determine the artist index value for different time periods. In step 118, data analyzed in step 114 can be aggregated to create broader market sector indices, such as a contemporary art index. In step 120, the index generation system also allows for several report varieties, which track the performance of individual artists, market sectors, or comparable sets from an artist's career.

Comparable Identification

Identifying and organizing comparable artworks for individual artists plays an important role in the development of art indices. As outlined above, it intends to expand the dataset examined when using a form of repeat sales. Increased heterogeneity could bias the model, making it imperative to ensure that all items in a comparable set display a high level of homogeneity, to pass both subjective tests by art scholars and objective tests by statistical analysts.

To determine the makeup of comparable sets, information on the artist and his or her historical significance is researched by one or more art analysts. When necessary, outside experts may also be consulted to determine what attributes of a particular artist most affect their market value. The system then extracts the artist's auction records from an art database, and the analysts organize and group the art works. Generally, the first step is to make distinctions between media, date ranges, subject matters, periods, and series. Analysts then examine core characteristics of the artwork, such as size, for each comparable set, such as size, and visually control for style, form, composition, color, and motif. Information from external sources, such as auction catalogues, may also be used to refine the categorization judgments and spot aberrations or outliers. The comparable sets are controlled for quality via an internal review process, which includes another visual consistency check. The analysts may comprise one or more certified appraisers and analysts with major auction house experience.

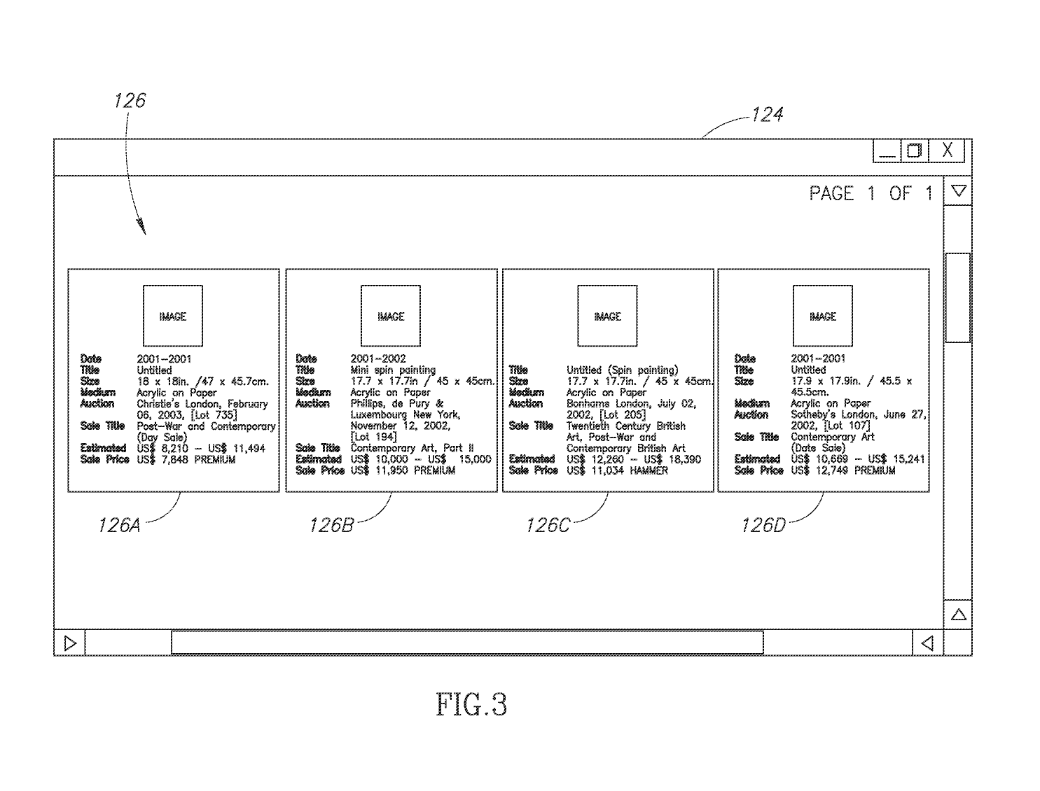

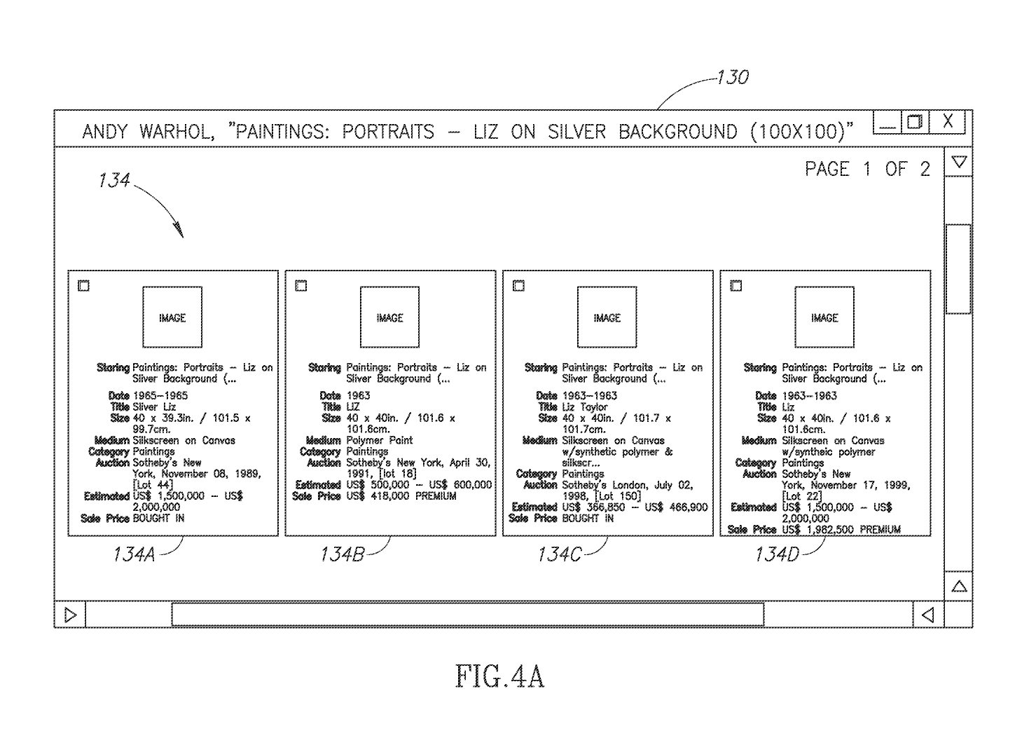

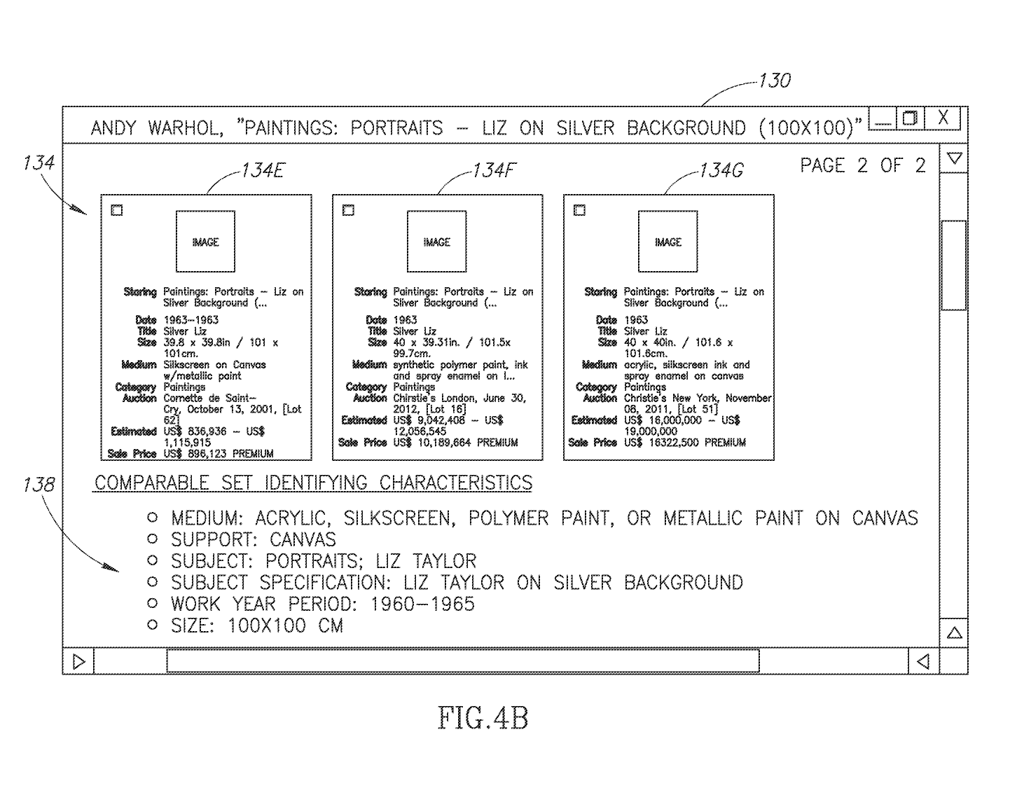

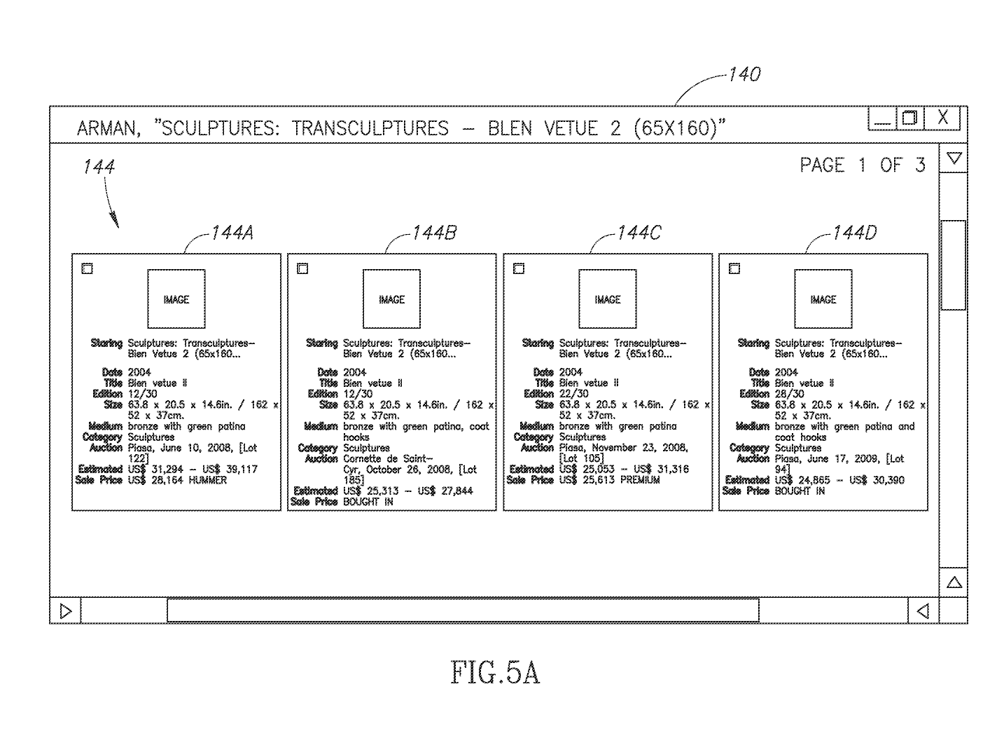

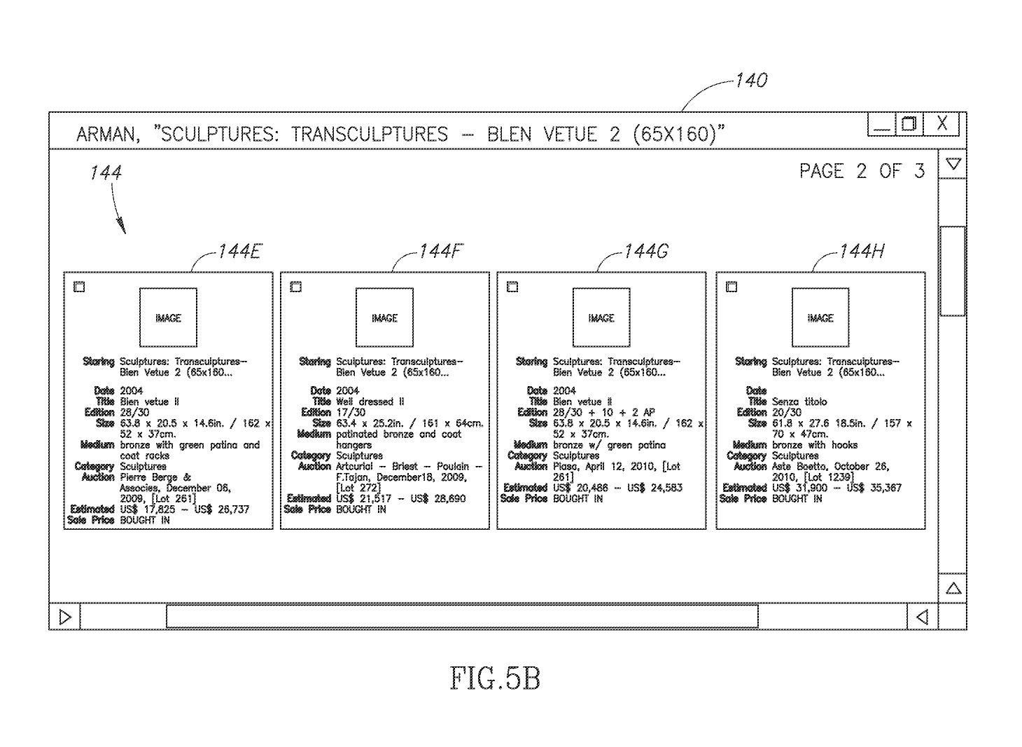

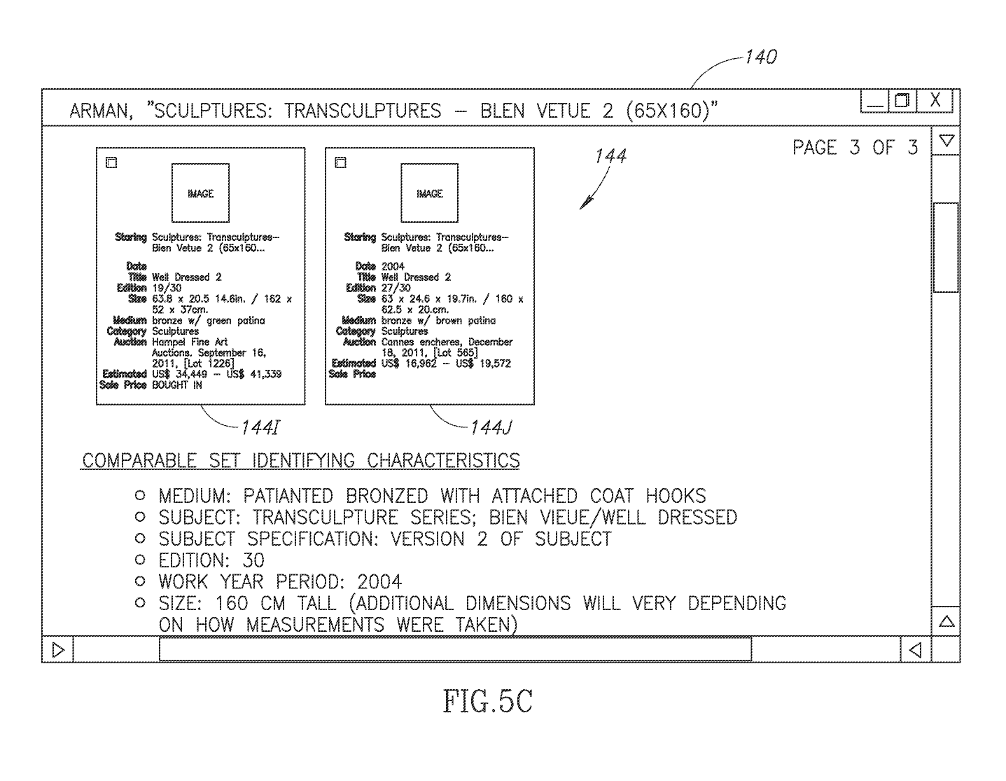

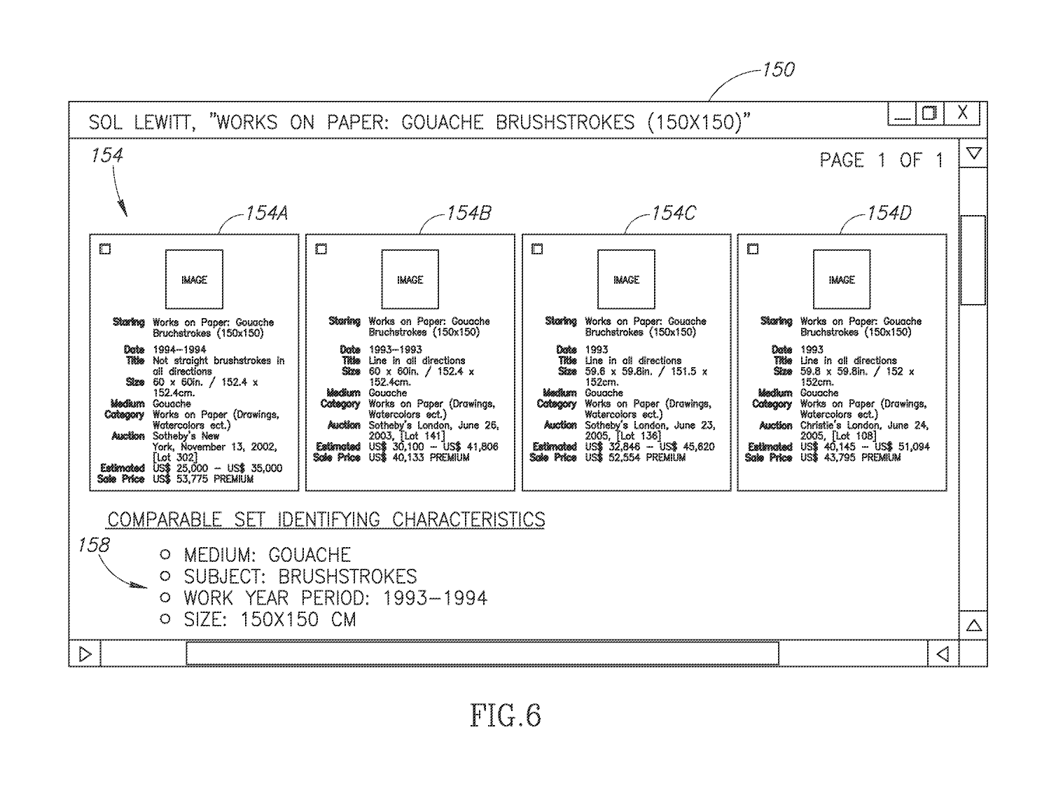

FIG. 3 is screenshot 124 of a comparable set 126 of artworks 126A-126D for Damien Hirst (British, b. 1965). FIGS. 4A and 4B collectively illustrate a screenshot 130 of a comparable set 134 of artworks 134A-134G for Andy Warhol “Paintings: Portraits—Liz on Silver Background (100×100).” As shown in FIG. 4B, a list of six comparable set identifying characteristics 138 are provided. In this example, the comparable set identifying characteristics are: (1) Medium—acrylic, silkscreen, polymer paint, or metallic paint on canvas; (2) Support—canvas; (3) Subject—portraits, Liz Taylor; (4) Subject Specification: Liz Taylor on silver background; (5) Work Year Period—1960-1965; and (60) Size—100 cm×100 cm. FIGS. 5A, 5B, and 5C collectively illustrate a screenshot 140 of a comparable set 144 of artworks 144A-144J for Arman, “Sculptures: Transculptures—Bien Vetue 2 (65×160).” In this example, a list of three comparable set identifying characteristics 148 is provided that includes: (1) Medium—patinated bronze with attached coat hooks; (2) Subject: transculpture series, bien vêtue/well dressed; and (3) Subject Specification: version 2 of subject. FIG. 6 illustrates a screenshot 150 of a comparable set 154 of artworks 154A-154D for Sol Lewit, “Works on Paper: Gouache Brustrokes (150×150).” In this example, a list of five comparable set identifying characteristics 158 is provided that includes: (1) Medium—Gouache; (2) Subject—brushstrokes; (3) Work Year Period: 1993-1994; and (4) Size: 150 cm×150 cm. It will be appreciated that other types and numbers of comparable sets and comparable set identifying characteristics may be used.

Artist Index Value Calculation

For a more in-depth understanding of how the index value calculations are computed, refer to the “Calculations” section below, which outlines the various calculation methods used to generate the index values and other values necessary to maintain accuracy.

Market Index Value Calculation

A discussion of how artists are selected to represent a market index, such as Contemporary or Latin American, and how the end market index values are generated, is provided below.

Index Presentation

Once all of the index values have been calculated, the resulting index is presented online in an interactive report that can be printed or downloaded by users as a PDF. To compare the performance of several indices with different base years, indices have been scaled to 100 in the earliest year all components were available. For financial indices that have been scaled, real values can be viewed on the right-hand Y-axis.

All indices can be viewed in either monthly or yearly segments, and users have the ability to customize the timeframe for each index graph. By changing the timeframe for each index, performance from a specific time onwards can be visualized.

Indices that represent a group of artists can also be customized to account for the distribution, or weight, of an artist's works within a collection. In creating an index line that represents a group of artists, users can change each artist's weight in the final combined index to reflect the exact composition of their particular collection. If custom weights are not applied, each artist will be given identical consideration in the final combined index.

In order to stay as up-to-date as possible, artist and market sector indices are updated on a monthly basis (or other suitable time period) to reflect the addition of new data to comparable sets, these updates may be available for purchase by users. Index values are subject to change as more information becomes available throughout the year.

For artists with sufficient sales history, users are able to combine or compare comparable sets for a single artist. The resulting index will represent the performance of the chosen comparable sets, and will begin in the earliest year a sale is recorded within the selection, regardless of when the artist's overall index begins.

Examples of Indices

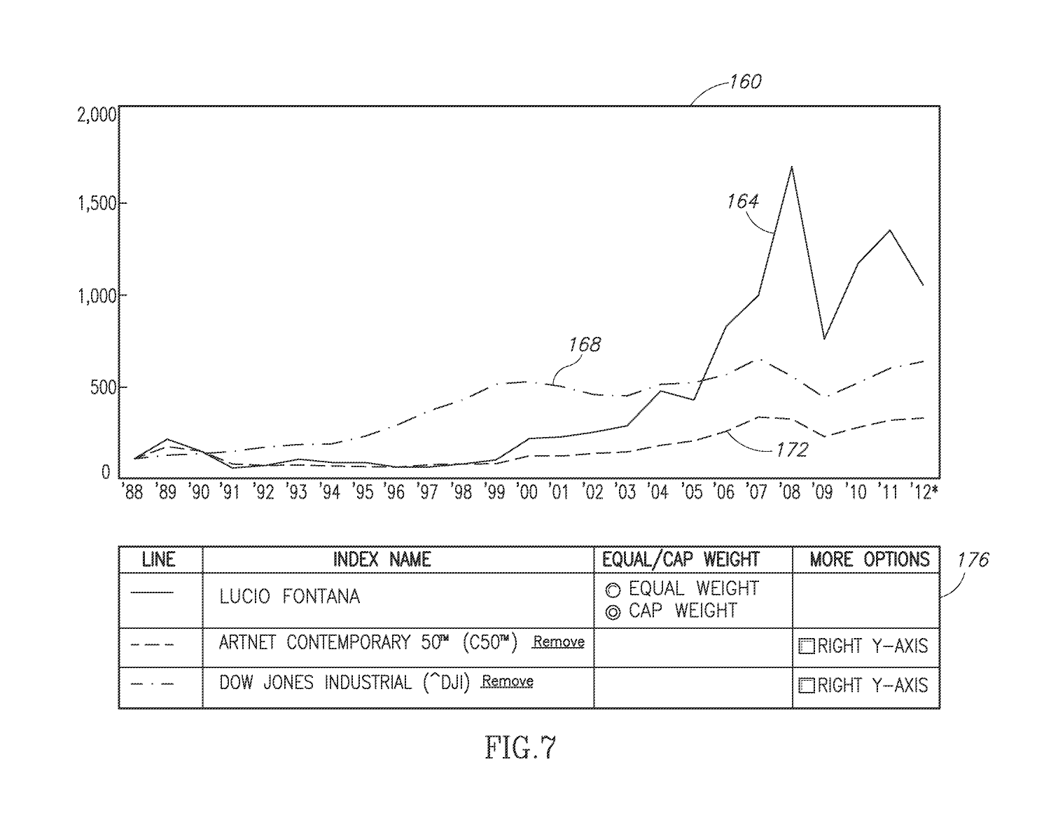

FIG. 7 illustrates an example of a report index graph 160 for an Artist Lucio Fontana 164, as compared with the ARTNET® C50™ Index—Contemporary Art 172, and the Dow Jones Industrial (DJI) index 168. A key 176 is provided below the graph 160, which also allows users to select equal weighting or cap weighting, and whether to display the ARTNET® C50™ Index—Contemporary Art 172, and the Dow Jones Industrial (DJI) index 168 on the right y-axis of the graph.

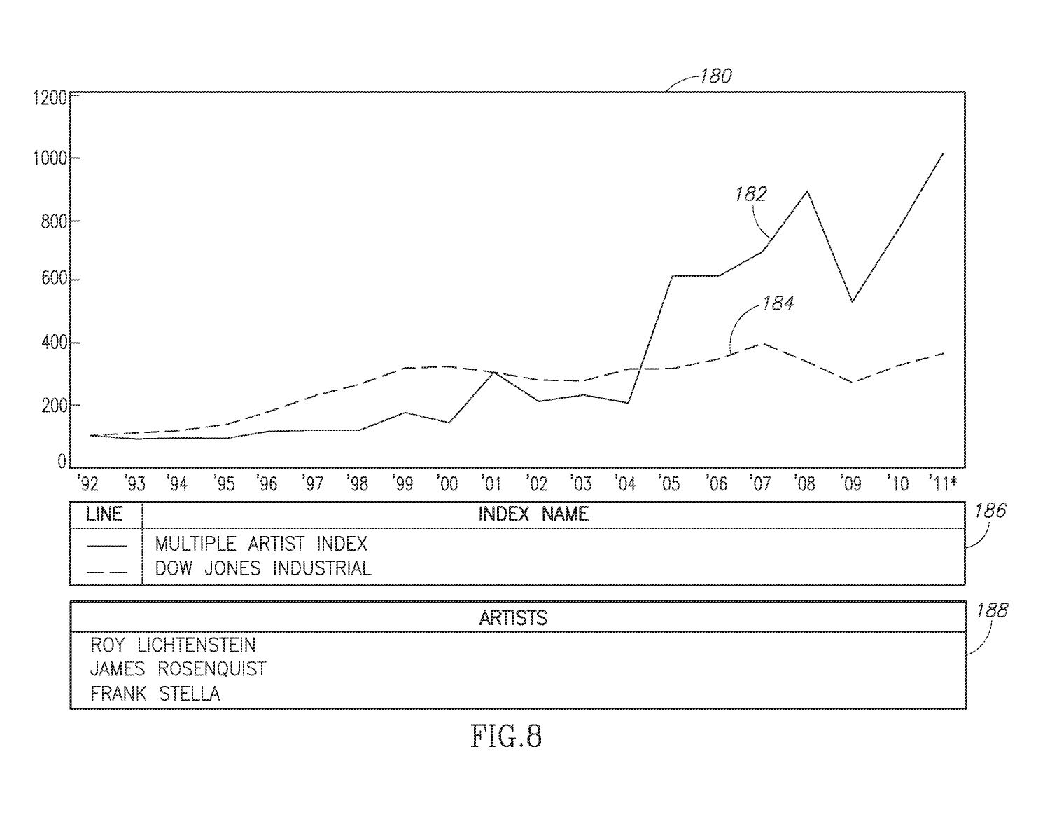

FIG. 8 illustrates a report index graph 180 for a multiple artist index 182 compared with the DJI index 184. A key 186 is provided. A list 188 of artists included in the index 182 is also provided. In this example, the artists include Roy Lichtenstein, James Rosenquist, and Frank Stella.

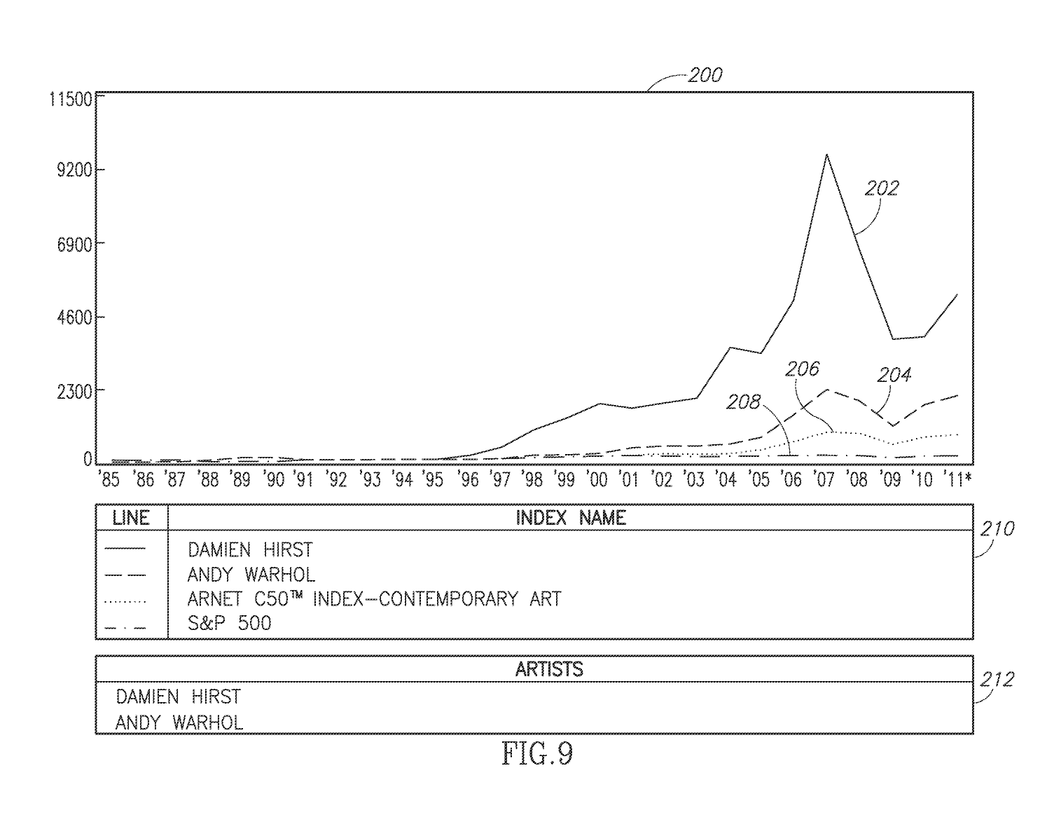

FIG. 9 illustrates a report index graph 200 showing a comparison of multiple artists. Specifically, as indicated by a key 210, the graph 200 illustrates an index for artists Damien Hirst 202, Andy Warhol 204, ARTNET® C50™ Index—Contemporary Art 206, and the S&P 500 index 208. The artists are listed in a box 212 shown in FIG. 9.

Calculations

As discussed above, the majority of published literature on art indices shows a preference for Hedonic Regression (HR) over the Repeat Sales Regression (RSR) used by financial indices. Many artists have limited data over time, diminishing the accuracy of a simple RSR approach. This data limitation has a severe effect on a traditional RSR model, leading to disruptive singularity issues when the amount of comparable sets is large with respect to the amount of data available within each set. However, the HR approach still suffers from limitations, such as the presence of characteristics that may change over time and affect value. These changes, and effects on value, may not be recorded by HR.

The indices generated by the present system combine the benefits of both RSR and HR in a more efficient, hybrid model, which treats RSR as a nested case of HR. See the section titled Repeat Sales as Nested Case of Hedonic Regression below. This approach follows the same principles as an RSR model, but adopts the structure of an HR model. Instead of considering price changes of comparable items by pairing sales, each sale is considered individually, identifying both the sale time (e.g., year, month) and comparable set membership as independent variables. The dependent variable is the log of the realized sale price minus the log average of sale prices for artworks in the same comparable set, unlike the log of price ratio used in traditional RSR models.

The index of the present system is initially estimated using data available in comparable sets with more than one sale point. As new lots are added to the art price database (e.g., from recent or historical sales), future index estimations may generate a slightly different value for a previously published index year. In such a case, like other financial indices, the present system utilizes an automated rectifier system that first checks if the past value falls within the confidence interval of the most recent estimation. The presence of the past value in this interval indicates that there is no statistically significant difference between the previous value and the most recent one, and thus, no action is taken. If the previous value falls outside of the confidence interval, then the past index value is replaced with the more recent value. The index generation methodology is capable of reacting quickly to this situation.

The system computes two types of art indices: a cap-weighted index and an equal-weighted index. The cap-weighted index is similar to the S&P 500 Market cap-weighted index, in which more weight is given to higher valued lots. The weights of each artwork in every index period are computed based on their performance in that period. The equal-weighted index is similar to the S&P 500 Equal-Weighted Index, as it gives equal importance to all the components constituting the index, irrespective of the difference in value.

Base Year Selection

In order to obtain a robust artist index in early years, when artists' data are limited, base years may be selected for each artist based on data overlap. The base year of an artist index will be in the earliest year when there are both a subsequent sale in one comparable set and an initial sale in another set. The index value in the base year may then be scaled to 100, and all index values in following years will be scaled to the base year.

Equal-Weighted Index

The equal weighted index is constructed by assuming that the natural logarithm of the price of an artwork i (i=1, . . . , N, where N is the total amount of artworks), belonging to comparable set s (s=1, . . . , S) and sold in time t (t=1, . . . , T) follows the following linear relationship:

$$log {( price )}_{i , s , t} = C + \frac{1}{{N}_{s}} {\sum }_{t = 1}^{T} {\sum }_{j = 1}^{{N}_{st}} log {( price )}_{j , s , t} = C + {\sum }_{t = 1}^{T} {β}_{t} \times {time}_{i , t} + {\sum }_{s = 1}^{S} {α}_{s} \times Comparable {Set}_{i , s} + {ɛ}_{i , s , t} , \qquad ( 1 )$$

where C is a constant and time_{i,t} is a variable with a value of 1 when the artwork i has been sold in time t and 0 otherwise. Similarly, Comparable Set_{i,s} is a variable taking the value 1 when the artwork i belongs to Comparable Set s and 0 otherwise. N_{S} is the total amount of artworks belonging to Comparable Set “s” and N_{S,t} is the total amount of artworks belonging to Comparable Set s that were sold in time t. ε_{i,s,t} is an error term and is assumed to be normally distributed with mean 0 and constant variance σ².

βₜ and α_{S} are coefficients. The βₜ can be interpreted as the marginal impacts of time on the log price. By construction, the coefficient corresponding to the base period (t=0) is set to zero. Coefficients of all other periods are constructed with respect to this given base period. The price level of the base period is later set arbitrarily to 100, and the price level of other periods are adjusted accordingly.

$$log {( price )}_{i , s , t} - \frac{1}{{N}_{s}} {\sum }_{t = 1}^{T} {\sum }_{j = 1}^{{N}_{st}} log {( price )}_{j , s , t} = C + {\sum }_{t = 1}^{T} {β}_{t} \times {time}_{i , t} + {\sum }_{s = 1}^{S} {α}_{s} \times Comparable {Set}_{i , s} + {ɛ}_{i , s , t} . \qquad ( 2 )$$

Defining the corrected log price Y_{i,s,t}:

$${Y}_{i , s , t} = {log ( price )}_{i , s , t} - \frac{1}{{N}_{s}} {\sum }_{t = 1}^{T} {\sum }_{j = 1}^{{N}_{st}} {log ( prices )}_{j , s , t} , \qquad ( 3 )$$

where Y_{i,s,t} stands for the log price of each artwork corrected by the overall log price level of the set to which it belongs.

All differences between artworks are comprehensively caught by the time dummy variable time_{i,t} and the variable string_{i,s} as comparable artworks are grouped in the same set.

$$E ( {Y}_{i , s , t} ) = E ( C + {\sum }_{t = 1}^{T} {β}_{t} \times {time}_{i , t} + {\sum }_{s = 1}^{S} {α}_{s} \times {string}_{i , s} ) \qquad ( 4 )$$

In matrix form:

E|(Y)=E(XS) (5)

Under the Gauss-Markov assumptions, the Ordinary Least Squares (OLS) estimator of the β parameter is:

B=(X′X)⁻¹(X′Y). (6)

A price index with base value 100 is defined as:

Priceₜ=100×e^{β}^{ₜ} (7)

Or, alternatively as:

Priceₜ=Priceₜ₋₁×e^{(β}^{ₜ}^{-β}^{ₜ₋₁}⁾ (8)

TABLE 1

| Price | Time | Set | log (price)_{i, s, t} | Y_{i, s, t} |
|---|---|---|---|---|
| 2000 | 0 (Base | 1 | 7.60 | −0.56 |
| | period) | | | |
| 5000 | 1 | 1 | 8.52 | 0.35 |
| 5050 | 1 | 1 | 8.53 | 0.36 |
| 6000 | 1 | 2 | 8.70 | 0.20 |
| 3000 | 2 | 1 | 8.01 | −0.16 |
| 4000 | 2 | 2 | 8.29 | −0.20 |

In the example of Table 1 above, the matrices Y and X are:

$$Y = \begin{matrix}{Y}_{i , s , t} \\ - 0.56 \\ 0.35 \\ 0.36 \\ 0.20 \\ - 0.16 \\ - 0.2\end{matrix} X = \begin{matrix} & {time}_{1} & {time}_{2} & Comparable {Set}_{1} \\ 1 & 0 & 0 & 1 \\ 1 & 1 & 0 & 1 \\ 1 & 1 & 0 & 1 \\ 1 & 1 & 0 & 0 \\ 1 & 0 & 1 & 1 \\ 1 & 0 & 1 & 0\end{matrix}$$

Result of the OLS estimation procedure: B=(X′X)⁻¹(X′Y).

$$B = \begin{matrix}C & - 0.67 \\ {β}_{1} & 0.90 \\ {β}_{2} & 0.43 \\ {α}_{1} & 0.11\end{matrix}$$

The index is then computed as:

Indexₜ₌₀=100

Indexₜ₌₁exp(0.90)×100=245.96

Indexₜ₌₂exp(0.43)×100=153.73

Cap-Weighted Index

The index methodology of the present invention can be adapted to use a diagonal weight matrix allowing for more weight to be given to high valued works. An artwork i that belongs to comparable set s sold in time t is weighted by a ratio with a numerator representing the average price of all artworks from set s sold in time t. The denominator is the sum of prices of all artworks sold in time t:

$$\begin{matrix}{Ω}_{i , s , t} = \frac{\frac{1}{{N}_{s , t}} {\sum }_{j = 1}^{{N}_{s , t}} {price}_{j , s , t}}{{\sum }_{s = 1}^{{S}_{t}} {\sum }_{j = 1}^{{N}_{s , t}} {price}_{j , s , t}} \times {time}_{i , t} \times {string}_{i , s} , & ( 9 ) \\ W = diag ( {Ω}_{1 , 1 , 1} , … , {Ω}_{i , s , t} , … , {Ω}_{N , S , T} ) , & ( 10 ) \\ B = {( {X}^{′} WX )}^{- 1} ( {X}^{′} WY ) . & ( 11 )\end{matrix}$$

The cap-weighted index uses the equal-weighted Index procedure until the index calculation stage, at which point the price index is constructed with a weight matrix.

TABLE 2

| Price | Time | Set | Weights | log(Price) | Y |
|---|---|---|---|---|---|
| 2000 | 0 (Base | 1 | 2000/2000 = 100% | 7.60 | −0.56 |
| | period) | | | | |
| 5000 | 1 | 1 | ((5000 + 5050)/2)/ | 8.52 | 0.35 |
| | | | 16050 = 31.3% | | |
| 5050 | 1 | 1 | ((5000 + 5050)/2)/ | 8.53 | 0.36 |
| | | | 16050 = 31.3% | | |
| 6000 | 1 | 2 | 6000/16050 = 37.4% | 8.70 | 0.20 |
| 3000 | 2 | 1 | 3000/7000 = 42.9% | 8.01 | −0.16 |
| 4000 | 2 | 2 | 4000/7000 = 57.1% | 8.29 | −0.20 |

In the example of Table 2 above, the matrices Y, X, and W are:

$$Y = \begin{matrix}{Y}_{i , s , t} \\ - 0.56 \\ 0.35 \\ 0.36 \\ 0.20 \\ - 0.16 \\ - 0.2\end{matrix} X = \begin{matrix} & {time}_{1} & {time}_{2} & Comparable {Set}_{1} \\ 1 & 0 & 0 & 1 \\ 1 & 1 & 0 & 1 \\ 1 & 1 & 0 & 1 \\ 1 & 1 & 0 & 0 \\ 1 & 0 & 1 & 1 \\ 1 & 0 & 1 & 0\end{matrix}$$

$$W = [ \begin{matrix}1 & 0 & 0 & 0 & 0 & 0 \\ 0 & 0.313 & 0 & 0 & 0 & 0 \\ 0 & 0 & 0.313 & 0 & 0 & 0 \\ 0 & 0 & 0 & 0.374 & 0 & 0 \\ 0 & 0 & 0 & 0 & 0.429 & 0 \\ 0 & 0 & 0 & 0 & 0 & 0.571\end{matrix} ]$$

Result of the OLS estimation procedure:

$$B = {( {X}^{′} WX )}^{- 1} ( {X}^{′} WY ) . \\ B = \begin{matrix}C & - 0.66 \\ {β}_{1} & 0.89 \\ {β}_{2} & 0.43 \\ {α}_{1} & 0.10\end{matrix} ,$$

the index is then computed as:

Indexₜ₌₀100

Indexₜ₌₁exp(0.89)×100=243.51

Indexₜ₌₂exp(0.43)×100=153.73

Monthly Calculation Method

The linear model used to estimate the index is based on a discrete function of time. As a consequence, the index estimation depends on frequency of new data entering the dataset. The model extension presented employs a common data-based procedure to provide more useful monthly updates of price levels.

This methodology is based on a standard approach that includes forwarding the most recent value of an artist's individual price level in the composition of the index. Duplicating the most recent past prices in certain conditions is a procedure commonly deployed by composite indices providers (e.g., Nasdaq −100 Index).

In the case of embodiments of the present invention, data completion occurs at the base level: the time discretization of equation (1) contracts to a monthly level to provide an estimation of monthly returns of each artist. In absence of new data, past observations from the previous time period are forwarded up to a logical threshold at which point the new observations take over. In practice, this yields a zero-return at artist's level but allows for computation of a monthly composite index.

In the following example shown in Table 3 below, a composite index is made of two artists. Artist one did not appear in the auction market in month two, while artist two did not appear in month three:

TABLE 3

| Artists | Month | β | N |
|---|---|---|---|
| 1 | 1 | 0.12 | 30 |
| 2 | 1 | 0.23 | 40 |
| 2 | 2 | 0.22 | 50 |
| 1 | 3 | 0.13 | 20 |

For each artist, last prices are forwarded in their respective datasets. Completion eventually produces the following results shown in Table 4:

TABLE 4

| Artists | Month | β | N |
|---|---|---|---|
| 1 | 1 | 0.12 | 30 |
| 2 | 1 | 0.23 | 40 |
| 1 | 2 | 0.12 | 30 |
| 2 | 2 | 0.22 | 50 |
| 1 | 3 | 0.13 | 20 |
| 2 | 3 | 0.22 | 50 |

Subsequently, the monthly index is computed:

$${Index}_{t = 0 , \{ artist 1 , artist 2 \} = 100}$$

$${Index}_{t = 1 , \{ artist 1 , artist 2 \} = \frac{( exp ( 0.12 - 0 ) \times 30 + exp ( 0.23 - 0 ) \times 40 ) \times 100}{70} = 120.24}$$

$${Index}_{t = 2 , \{ artist 1 , artist 2 \} = \frac{( exp ( 0.12 - 0.12 ) \times 30 + exp ( 0.22 - 0.23 ) \times 50 ) \times 120.24}{80} = 119.42}$$

$${Index}_{t = 3 , \{ artist 1 , artist 2 \} = \frac{( exp ( 0.13 - 0.12 ) \times 20 + exp ( 0.22 - 0.22 ) \times 50 ) \times 119.42}{70} = 119.76}$$

Confidence Interval

The confidence interval provides vital information regarding the effectiveness of the indices. It also plays a significant role in determining whether past index values need to be revised. The methodology requires the confidence interval to be calculated.

To calculate an asymptotic confidence interval for the equal-weighted index, an error matrix is first computed using the following equation:

e=Y−Ŷ=Y−X(X′X)⁻¹X′ (12)

Next, the sum of squared errors (SSE) and mean square error (MSE) are calculated using the elements from the error vector e using:

SSE=Σᵢ₌₁^{N}εᵢ² (13)
where εᵢ are the elements of vector e.

$$M S E = \frac{S S E}{N - p} \qquad ( 14 )$$

where p is the amount of columns in matrix X.

Defining the variance-covariance:

(X′X)⁻¹MSE (15)

This is a p by p matrix with diagonal elements indicating the square of the standard errors of the estimated regression parameters. Finally, the confidence interval for any parameter βₜ is calculated using:

Cl_{β}_{ₜ}=\hat{β}ₜ±t*×s(βₜ), (16)

where s(βₜ) is the standard error of the βₜ parameter and where t* is the critical value of t-distribution with N-p degrees of freedom.

In the case of the cap-weighted index, equation (14) must be adjusted as follows:

$$M S E = \frac{{Y}^{′} ( W - WX ( {( {X}^{′} WX )}^{- 1} {X}^{′} W ) Y}{N - p} \qquad ( 17 )$$

Equation (15) becomes:

(X′WX)⁻¹MSE (18)

Market Indices

In addition to artist specific indices, embodiments of the present invention are also operative to calculate broader indices for various markets. These market indices are calculated by examining, though not bound to, the categorization methods used by auction houses.

The first market index to be released by Artnet® analysts was the artnet C50™ Index. This index is tracked based on the performance of the 50 top-ranked artists within the Contemporary Art market each year. Other indices, such as the Impressionist Art Index and the Modern Art Index, are also based on the performance of the top-ranked artists within their respective category each year.

Selection of Artists for Market Sector Indices

In some embodiments, artists are ranked based on their yearly performance. The rank for each artist in a given year is used in an exponential decay formula that goes back five years. The resulting rank value generated is used to determine the final ranking for all artists.

More specifically, in some embodiments, artists are ranked using the following steps:
a. Determine universe of artists in the market sector based on their style, birth and death years, and art movements associated with them.
b. Compute total lots sold and median price for each artist per year, excluding prints.
c. Multiply median price by sold lots. The result will be hereafter referred to as m.
d. Generate the overall rank for year x by using the value m in an exponential decay going back five years. For example:

Overall Rank in year x=[(mₓ₋₁*exp⁰)+(mₓ₋₂*exp⁻¹)+(mₓ₋₃*exp⁻²)+(mₓ₋₄*exp⁻³)+

(mₓ₋₅*exp⁻⁴)+(mₓ₋₆*exp⁻⁵)].

e. After the decay is performed, the artists with the highest overall rank in year x are included in the computation of the sector index for year x.

Composite Index Calculations

Composite indices (i.e., one comprised of multiple artists) are calculated in a single step, based on equation (1), by merging all comparable sets of artists. An equal-weight index is derived due to a weight matrix that forces the model to give each artist the exact same importance:

$${ξ}_{a , t} = \frac{{N}_{t}}{{n}_{a , t} \times {A}_{t}} , \qquad ( 19 )$$

where Nₜ is the total amount of artworks sold at time t and n_{a,t} is the amount of artworks from artist a sold at time t. Aₜ is the total amount of artists for whom at least one transaction was observed at time t. The equal-weight matrix is:

Ξ=diag(ξ_{α,t})_{N×N} (20)

The parameters are then estimated using OLS:

B=(X′ΞX)⁻¹(X′ΞY) (21)

By extension, a cap-weighted composite index is obtained in a similar way:

B=(X′ΞΩX)⁻¹(X′ΞΩY). (22)

Composite Index Yearly Adjustment

At the end of every calendar year, a new group of artists is selected for the composite indices based on their performance in the previous year. Once this ranking process is complete, the composite index will be recalculated on the first business day in January to reflect the new group of artists. The composite index values generated in early January will then be scaled to the closing value for December of the previous year. This adjustment will ensure that composite indices remain stable even after the artists included in the index change. All subsequent months will follow this scaling logic.

Repeat Sales as Nested Case of Hedonic Regression

Consider a sale of item i at time t₁ at price p_{i,t1}. Given that the item has h characteristics, a hedonic regression for this item can be written as:

$$log ( {p}_{i , {j}_{1}} ) = {\sum }_{k = 1}^{K} {α}_{k} {h}_{i , k} + {\sum }_{τ = 0}^{T - 1} {β}_{τ} {d}_{i , τ} + {η}_{i , {t}_{1}}$$

Where h_{(.),k} is the k^{th} characteristics of the item i and d_{(.),τ} is the indicator variable which takes the value of 1 if the item is sold in the time period τ, else 0.

Consider another item j which is sold in time t₂ (where t₁>t₂) and at price p_{j,t2}. With the item having h characteristics, the hedonic regression model for item j is as follows:

$$log ( {p}_{i , {j}_{2}} ) = {\sum }_{k = 1}^{K} {α}_{k} {h}_{j , k} + {\sum }_{τ = 0}^{T - 1} {β}_{τ} {d}_{j , τ} + {η}_{j , {t}_{2}}$$

Considering a repeat sales model, where both i and j are same items, and their price difference is the parameter of interest, the hedonic regression form of this repeat sales model is:

$$log ( {p}_{i , {t}_{1}} ) - log ( {p}_{j , {t}_{2}} ) = ( {\sum }_{k = 1}^{K} {α}_{k} {h}_{i , k} + {\sum }_{τ = 0}^{T - 1} {β}_{τ} {d}_{i , τ} + {η}_{i , {t}_{1}} ) - ( {\sum }_{k = 1}^{K} {α}_{k} {h}_{j , k} + {\sum }_{τ = 0}^{T - 1} {β}_{τ} {d}_{j , τ} + {η}_{j , {t}_{2}} )$$

Since, the characteristics h are common across both items, the above model is reduced to:

$$log ( \frac{{p}_{i , {t}_{1}}}{{p}_{j , {t}_{2}}} ) = ( {\sum }_{τ = 0}^{T - 1} {β}_{τ} {d}_{i , τ} ) - ( {\sum }_{τ = 0}^{T - 1} {β}_{τ} {d}_{j , τ} ) + ζ$$

Where the indicator variable d_{(.),τ} is −1 for time t₂ and +1 for time t₁. The above equation is the same form as the traditional repeat sales model, and thus proof shows that the repeat sale is a form of hedonic regression.

Data Standardization

The indices described herein may be based on Comparable Sets that use public auction sales data extracted from the Artnet® Price Database, or other art database. Although most auction houses report transaction prices that include a buyer's premium, some auction houses only report hammer prices. Based on an analysis of historical auction catalogs, embodiments of the present invention apply a formula to all records with hammer prices, only to estimate the effect of a buyer's premium. All prices in the Analytics Reports are therefore either reported as, or equated to, the hammer price plus a buyer's premium.

Index Revisions

In some embodiments, the system may adhere to the same strict data revision logic as the S&P Case Schiller methodology. See “S&P/Case-Shiller Home Price Indices.” Index Methodology. S&P/Case-Shiller, November-December 2009, Web. 30 Jan. 2012, page 33. The revising of index data may be based on new information not previously recorded. One such example being, when an auction house, newly added to the system, has sales results published in a database (e.g., the ARTNET® Price Database), sales data for as far back as the new auction house can provide are added to the database and then to the indices managed by the system. When the new data are entered, a comparison is made between the index values prior to and after the addition. If the index values move outside of the first index's confidence interval, then the new index values replace the prior values. In the event that the index stays within the confidence interval, no change is made. This in-house data management system allows a constant monitoring of data to maximize accuracy.

### CONCLUSION

The methodology described herein successfully incorporates the unique characteristics of art, while maintaining the accuracy of repeat sales. Multiple variations of the final index creation process have been tested against one another to determine the best and most accurate calculation method. These tests confirmed that the index methodology described above performs extremely well. In addition, safeguards have been developed and put in place to ensure that the indices are dynamic enough to accommodate additional data from any time period. The information the indices described herein makes available to users is more powerful than any other art analysis tool currently available.

Computing System

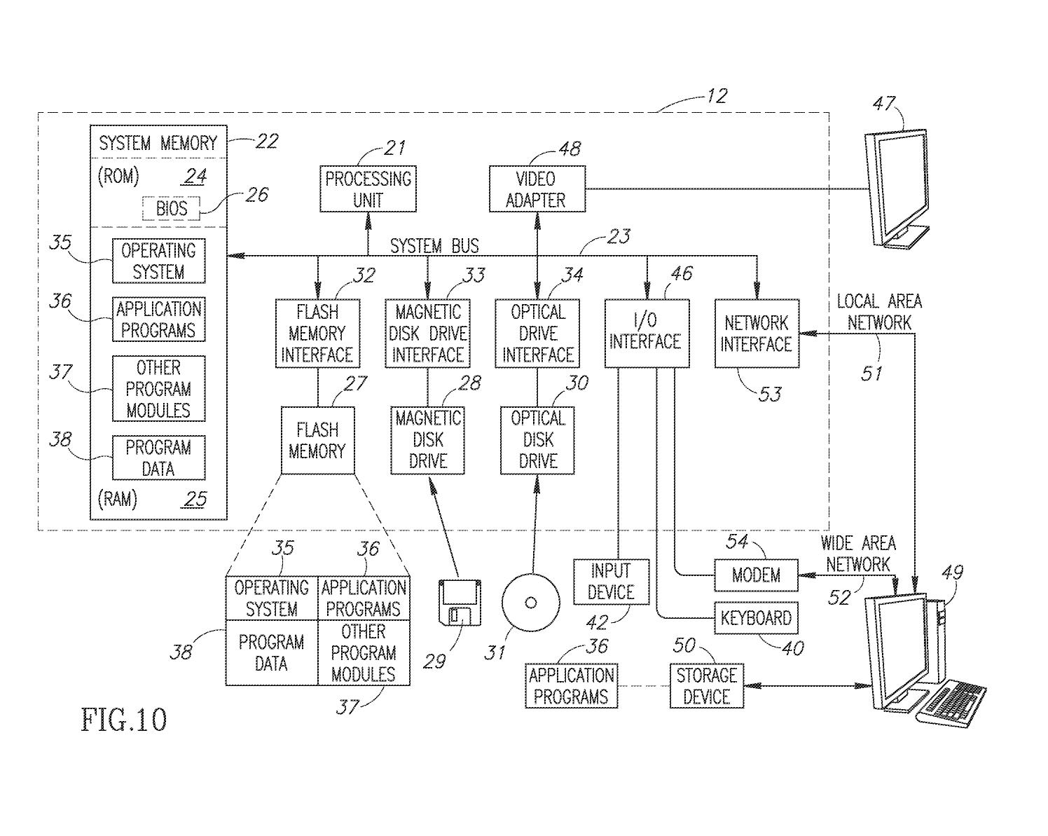

FIG. 10 is a diagram of hardware and an operating environment in conjunction with which implementations of the art indices generation and reporting processes may be practiced. The description of FIG. 10 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 10 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, a mobile computing device, or any other type of computing device.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 10 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

We claim:

1. A computer-implemented method for developing an art index, comprising:
receiving in a database a plurality of variables representative of characteristics of an artist or the artist's art objects, the plurality of variables including sales prices for the artist's art objects;
automatically analyzing the plurality of variables using a processor to determine a comparable set of art objects comprising a group of comparable art objects produced by the artist that have similarities in one or more attributes, including year of work, medium, genre, size, or valuation; and
automatically estimating an art index value for the artist at a plurality of time periods using the processor by considering the sales prices for all sales of the art objects within the comparable set individually and a time period for each sale.

2. The method of claim 1, further comprising: developing a broader market index by repeating the steps of claim 1 for a plurality of artists, and aggregating the indices for the plurality of artists.

3. The method of claim 2, wherein the aggregating comprises giving more weight to higher valued comparable sets than to lower valued comparable sets.

4. The method of claim 1, wherein analyzing the comparable set comprises utilizing historical sales data for the art objects in the comparable set.

5. The method of claim 1, wherein analyzing the comparable set comprises evaluating one or more characteristics of the art objects, including artist name, medium, or subject matter.

6. The method of claim 1, further comprising generating an interactive report for display, wherein the interactive report includes a graph of the art index value versus time.

7. The method of claim 1, wherein estimating an art index value comprises consideration of both individual characteristics of the art objects and sales prices of the art objects over time.

8. The method of claim 1, wherein estimating an art index value comprises giving more weight to higher valued art works than to lower valued art works in the comparable set.

9. The method of claim 1, wherein estimating an art index value comprises giving equal weight to each art work in the comparable set.

10. The method of claim 1, further comprising automatically calculating a confidence interval for the art index value, and utilizing the calculated confidence interval to automatically decide whether to update the art index value with a subsequent art index value estimation.

11. The method of claim 1, further comprising selecting a plurality of artists for inclusion in a market sector index by identifying a group of artists in a market sector, generating a rank score for each artist based on sold art works over a period of time, and selecting the artists in the group of artists having the highest rank score for inclusion in the market sector index.

12. A computing system for developing an art index, comprising:
a data storage including a plurality of variables representative of characteristics of artists or their art works;
an analysis module executable on a processor of the computing system configured for analyzing the plurality of variables to determine a comparable set of art objects comprising a group of comparable art objects produced by the artist that have similarities in various attributes, including year of work, medium, genre, size, or valuation; and
an estimation module executable on the processor of the computing system configured for estimating an art index value for the artist at a plurality of time periods by considering the sales prices for all sales of the art objects within the comparable set individually and a time period for each sale.

13. The computing system of claim 12, further comprising a reporting module executable on the processor of the computing system configured for generating an index graph for the art index value.

14. The computing system of claim 12, wherein the estimation module is configured for determining a broader market index by estimating a plurality of art index values for a plurality of artists, each art index value being based on a comparable set, and merging the plurality of art index values together to form the broader market index.

15. The computing system of claim 14, wherein merging the plurality of art index values together comprises giving more weight to higher valued comparable sets than to lower valued comparable sets.

16. The computing system of claim 12, wherein the analysis module is configured to evaluate one or more characteristics of the art objects, including artist name, medium, or subject matter.

17. The computing system of claim 12, wherein the estimation module is configured to consider both individual characteristics of the art objects and changes in price of the art objects over time.

18. The computing system of claim 12, wherein the estimation module is configured to give more weight to higher valued art works than to lower valued art works in the comparable set.

19. The computing system of claim 12, wherein the estimation module is configured to give equal weight to each art work in the comparable set.

20. A computer readable medium having computer-executable components for performing a process of automatically developing an art index, the process comprising:
receiving in a database a plurality of variables representative of characteristics of an artist or the artist's art objects, the plurality of variables including sales prices for the artist's art objects;
automatically analyzing the plurality of variables using a processor to determine a comparable set of art objects comprising a group of comparable art objects produced by the artist that have similarities in one or more attributes, including year of work, medium, genre, size, or valuation; and
automatically estimating an art index value for the artist at a plurality of time periods using a processor by considering the sales prices for all sales of the art objects
within the comparable set individually and a time period for each sale.
